(19) United States
(12) Patent Application Publication
(10) Pub. No.: US 2005/0135494 A1
(43) Pub. Date: Jun. 23, 2005

(54) Forming multi-carrier signals

(76) Inventors: Richard Kybett, Camberley (GB); Olli Pitrainen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/813,648

(22) Filed: Mar. 31, 2004

(30) Foreign Application Priority Data
Apr. 15, 2003 (GB) GB 0308701.2

(51) Int. Cl. H04K 1/10

(52) U.S. Cl. 375/260

(57) ABSTRACT

A method for forming a multi-carrier output signal for transmission in a communication system, the multi-carrier output signal being formed from a plurality of data signals each modulated with a respective one of a plurality of carrier signals, the method comprising: establishing two or more sets of carrier signals, each set comprising each of the plurality of carrier signals and differing from the other set(s) in the phase of at least one of the carrier signals; selecting the one of the sets of carrier signals that would, when used to form the multi-carrier signal, result in the multi-carrier output signal having the lowest maximum amplitude; and forming the multi-carrier output signal from the plurality of data signals each modulated with the respective one of the plurality of carrier signals of that selected set.

This invention relates to forming multi-carrier signals, and especially to techniques for reducing the peak-to-average power ratio of such signals. The invention is especially applicable to the EDGE (enhanced data for GSM evolution) system.

Transmitters for transmitting signals typically include a signal generation section which generates the signal that is to be transmitted, and an amplification section which amplifies the signal for transmission by using a power amplifier (PA). When operating a linearised transmitter it is only possible to linearise up to the saturated output power of the PA being used; beyond this no more power is available and the linearised system will act like a hard limited system. Clipping the peaks of a varying envelope signal (such as any multi-carrier signal) will cause distortion and spectral spreading, with the potential to cause a significant error vector magnitude (EVM). In the case of an EDGE modulated system this will result in intermodulation distortion (IMD), but there is a very tight limit on intermodulation distortion of ˜70 dBc, as specified in GSM 0505. As a result, clipping is of limited use.

In order to avoid clipping and failure to meet the above IMD requirement it is generally necessary that any amplifier used has a peak power capability equal to the level of the expected signal peaks. This has two major implications:

i) The size of the amplifier (and therefore the cost of the silicon on which it is typically formed) is set by the peak power requirement, not the average. Therefore, selecting an amplifier that meets the peak power requirement requires a larger amplifier than would otherwise be called for.

ii) The efficiency of the amplifier will be based on an average power which is backed off from saturation by an amount at least equal to the PAR (peak-to-average ratio), and will therefore not be optimum.

From these 2 points it can be seen that a large PAR will result in a large expensive amplifier that is running inefficiently, and it is for this reason that PAR reduction techniques are used wherever possible.

FIG. 1 shows the PAR of a high power class AB LDMOS amplifier (Psat>400 W) at ranges of back-off from saturation power (Psat). The figure shows that the amplifier has a power added efficiency of over 40% when operating at full saturated power, whereas at a back off of 9 dB the efficiency has dropped to approx 17%. Although the slope of the efficiency curve can be adjusted somewhat for different amplifier designs, as long as a class AB (linear) amplifier is used then the slope will reduce as back off from Psat increases. For example, in comparison to the curve above a 1 dB improvement in PAR from 9 dB to 8 dB would result in an efficiency improvement from 17% to 19% and a peak power requirement, for a 32 W (45 dBm) average power transmitter, from 252 W to 200 W. This could save $72 per amplifier, assuming a cost of $1.4 per watt).

Peak to average ratio is a problem in all varying envelope modulation systems. Baseband clipping has long been used to limit the maximum peaks of signals in such systems.

The trade off between PAR reduction and peak code domain error is the limiting factor in how far the peaks can be reduced. This subject has been well documented and is not be discussed here.

In a multi-carrier EDGE system the carriers are added together, not in the baseband but in the RF domain (at least some frequency shift must be applied to achieve carrier separation, even in the digital domain), therefore the multi-carrier high PAR signal does not exist until after the baseband pulse shaping filters. This distinction means that any spectral spreading or distortion caused by clipping the signal cannot be recovered by the pulse shaping filters.

There is therefore a need for an improved way to form signals so as preferably to reduce the typical PAR and hence reduce the demands on the power amplifier of the transmitter.

According to one aspect of the present invention there is provided a method for forming a multi-carrier output signal for transmission in a communication system, the multi-carrier output signal being formed from a plurality of data signals each modulated with a respective one of a plurality of carrier signals, the method comprising: establishing two or more sets of carrier signals, each set comprising each of the plurality of carrier signals and differing from the other set(s) in the phase of at least one of the carrier signals; selecting the one of the sets of carrier signals that would, when used to form the multi-carrier signal, result in the multi-carrier output signal having the lowest maximum amplitude; and forming the multi-carrier output signal from the plurality of data signals each modulated with the respective one of the plurality of carrier signals of that selected set.

According to a second aspect of the present invention there is provided a transmitter for forming a multi-carrier output signal for transmission in a communication system, the multi-carrier output signal being formed from a plurality of data signals each modulated with a respective one of a plurality of carrier signals, the transmitter comprising: means for establishing two or more sets of carrier signals, each set comprising each of the plurality of carrier signals and differing from the other set(s) in the phase of at least one of the carrier signals; means for selecting the one of the sets of carrier signals that would, when used to form the multi-carrier signal, result in the multi-carrier output signal having the lowest maximum amplitude; and means for forming the multi-carrier output signal from the plurality of data signals each modulated with the respective one of the plurality of carrier signals of that selected set.

According to a third aspect of the invention there is provided a transmitter for forming a multi-carrier output signal for transmission in a communication system, the multi-carrier output signal being formed from a plurality of data signals each modulated with a respective one of a plurality of carrier signals, the transmitter being configured to: establish two or more sets of carrier signals, each set comprising each of the plurality of carrier signals and differing from the other set(s) in the phase of at least one of the carrier signals; select the one of the sets of carrier signals that would, when used to form the multi-carrier signal, result in the multi-carrier output signal having the lowest maximum amplitude; and form the multi-carrier output signal from the plurality of data signals each modulated with the respective one of the plurality of carrier signals of that selected set.

According to a fourth aspect of the invention there is provided a method for forming a multi-carrier output signal for transmission in a communication system, the multi-carrier output signal being formed from a plurality of data signals each modulated with a respective one of a plurality of carrier signals, the method comprising: establishing a set of carrier signals; determining the maximum amplitude of the multi-carrier signal that would result from modulating each of the plurality of data signals with the respective one of the plurality of carrier signals of that set; and if the determined maximum amplitude is below a pre-determined threshold, forming the multi-carrier signal by modulating each of the plurality of data signals with the respective one of the plurality of carrier signals of that set; and otherwise; altering the phase of at least one of the carrier signals of the set, and forming the multi-carrier signal by modulating each of the plurality of data signals with the respective one of the plurality of carrier signals of the set, including the at least one carrier signal having an altered phase.

Preferably the said step of establishing comprises: forming a first set of the plurality of carrier signals; and forming the or each other set of the plurality of carrier signals by duplicating a previously formed set of the carrier signals but with the phase of one or more of the carrier signals altered by a random amount. The random amount may be a pseudo-random amount.

Preferably the said step of establishing comprises: forming a first set of the plurality of carrier signals; and forming the or each other set of the plurality of carrier signals by duplicating a previously formed set of the carrier signals but with the phase of one or more of the carrier signals altered by a pre-determined amount. The pre-determined amount may be selected from a set of predetermined amounts. The set of predetermined amounts may be integer multiples of a single amount. Most preferably the set of predetermined amounts comprises one or more of the values: π/2, π, 3π/2. This allows a simple implementation since multiplications by only 1 and −1 may be used to perform those phase rotations.

Preferably the said step of selecting comprises: for each of the sets of carrier signals: forming a multi-carrier signal by modulating each of the data signals with the respective carrier signal of that set, combining the modulated signals and determining the maximum amplitude of the combined signal. Alternatively, the maximum amplitude may be determined by simulation.

Preferably the method comprises repeatedly forming one of the said sets of carrier signals and determining the maximum amplitude that the multi-carrier output signal would have if that set of carrier signals were used to form the multi-carrier signal, until the determined maximum amplitude is below a predetermined threshold. If none of a predetermined number of formed sets would result in the determined maximum amplitude being below the threshold then the one of those sets that would result in the lowest maximum amplitude may be selected.

The communication system may be GSM, WCDMA or EDGE communication system. Alternatively, it may be a system of another type.

The multi-carrier output signal is suitably a burst of the communication system. Alternatively it may be a longer or shorter signal block. Suitably the said selecting and forming steps are performed for each burst or other block. The said establishing step may be performed for each burst or other block or for several bursts/blocks.

Each of the data signals could comprise more or fewer than 100 symbols.

The method may comprise amplifying the multi-carrier output signal and transmitting the amplified signal via an antenna. Preferably the signal is amplified by means of a linear power amplifier.

The present invention will now be described by way of example, with reference to the accompanying drawings.

In the drawings:

FIG. 1 shows the PAR of a high power class AB LDMOS amplifier;

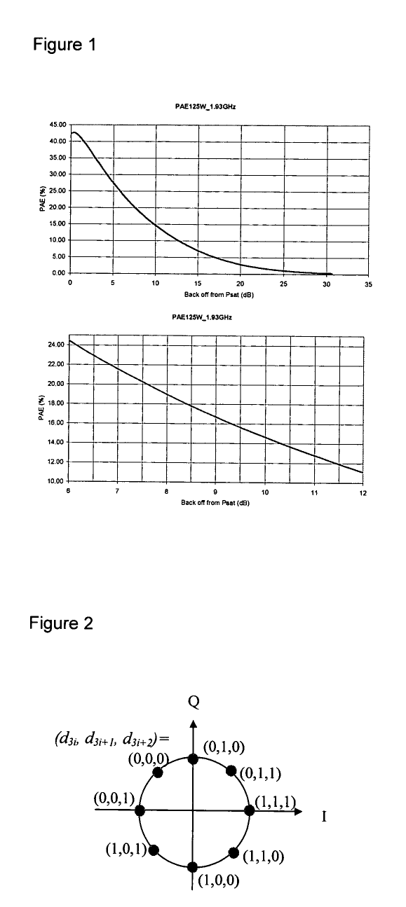

FIG. 2 shows the EDGE symbol mapping scheme;

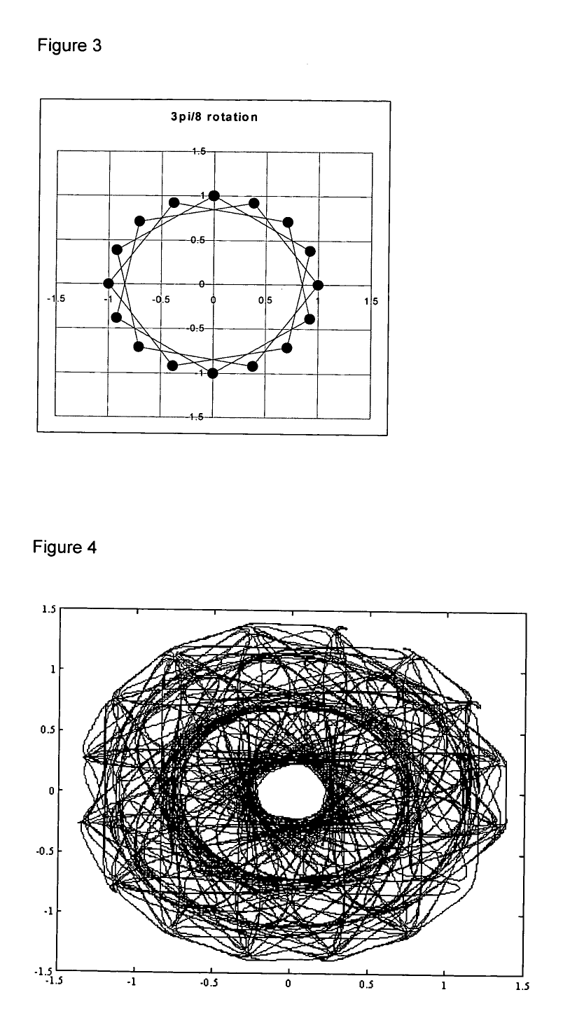

FIG. 3 illustrates the EDGE 3pi/8 offset scheme;

FIG. 4 shows the EDGE constellation diagram;

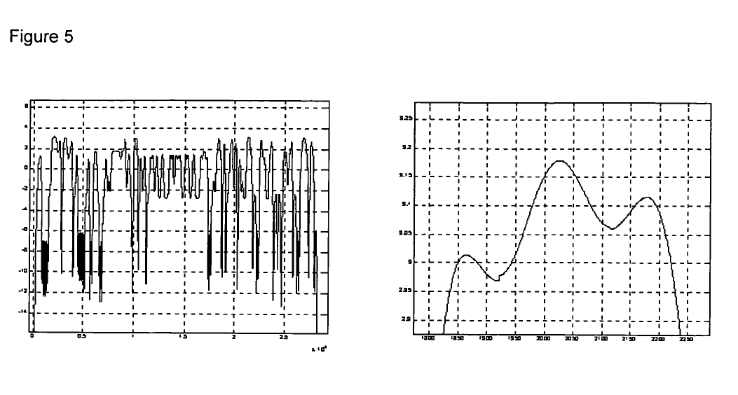

FIG. 5 shows the results of some simulations plotting PAR against time;

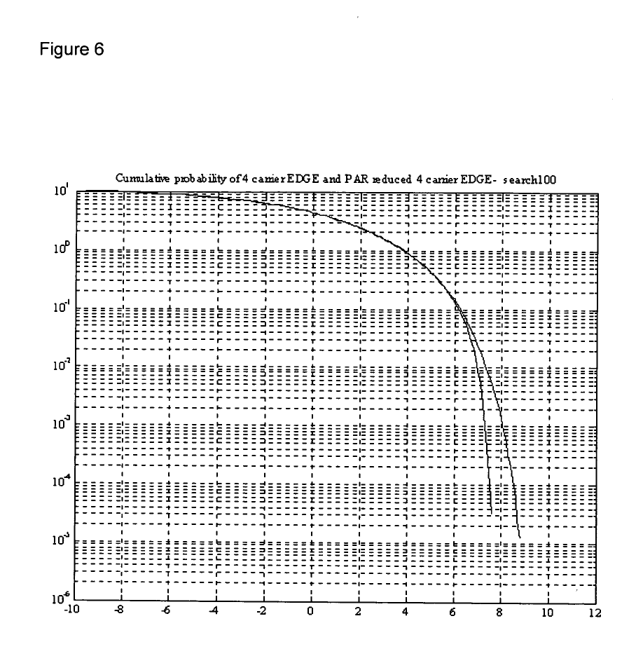

FIG. 6 shows the results of a modulation phase alteration algorithm; and

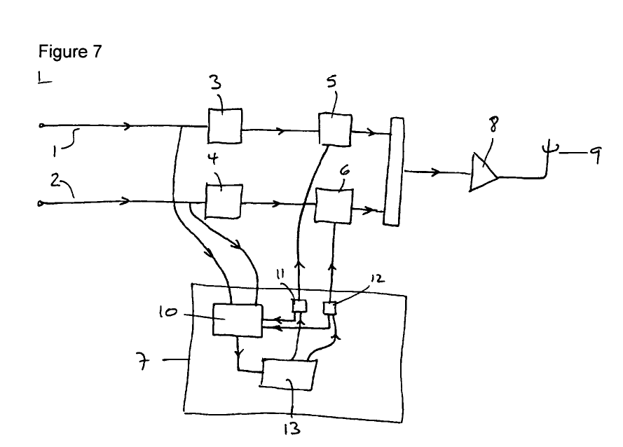

FIG. 7 shows apparatus for performing the phase alteration algorithm.

The modulation used in the EDGE system is specified in section 3 of the GSM 0504 standard document. It involves the following steps:

1) Symbol Mapping

Three data bits are combined using a Gray code to form an 8 psk symbol. The conversion from modulating bits to symbols is performed according to the following table.

| Modulating bits | Symbol |
|---|---|
| d3i, d3i + 1, d3i + 2 | parameter I |
| (1, 1, 1) | 0 |
| (0, 1, 1) | 1 |
| (0, 1, 0) | 2 |
| (0, 0, 0) | 3 |
| (0, 0, 1) | 4 |
| (1, 0, 1) | 5 |
| (1, 0, 0) | 6 |
| (1, 1, 0) | 7 |

The symbols are then mapped according to the scheme illustrated in FIG. 2.

2) Symbol Rotation

The symbols are continuously rotated by a 3pi/8 offset defined by
ŝᵢ=sᵢ·e^{ji3π/8}

This is illustrated in FIG. 3.

3) Pulse Shaping

The signal is then pulse shaped by a filter approximating the GSM system's general Gaussian spectral response. This results in a constellation diagram as shown in FIG. 4.

As a result of these steps a single carrier EDGE modulated signal has a PAR of approx 3.1 dB. For a multi-carrier EDGE signal, the worst-case PAR depends on the number of carriers. Typically, the worst case PAR of multi-carrier signals are as follows:
2 carrier=3 dB
4 carrier=6 dB
8 carrier=9 dB

If each of the carriers have EDGE modulation on them with a 3.1 dB PAR of its own then the worst-case PAR figures become:
2 carrier=6.1 dB
4 carrier=9.1 dB
8 carrier=12.1 dB

In order for a worst-case peak power to occur in practice in a multi-carrier system, it must happen that:
i) the modulation of the individual carrier signals must be at a peak amplitude; and at the same time
ii) the RF carriers (or separation frequency) must be of the same phase at the same time.

An EDGE symbol lasts 3.69 ms and peaks over 3 dB can be observed lasting approx 4.8 ms (250 clock cycles @ 52 MHz sample). To illustrate this, FIG. 5 shows the results of some simulations plotting PAR against time.

The statistical probability of certain peak powers occurring for multiple carrier EDGE signals has been analysed. Based on these results, the PARs that would be reached with a probability of 0.1% are:
2 carrier=6.3
4 carrier=8 dB
8 carrier=8.5 dB
16 carrier=9 dB

(In comparison the EDGE single-carrier PAR for this simulation was 3.6 dB). These figures are considerably less than the worst-case figures, and more statistical improvement results as the number of carriers increases.

In reality the different EDGE signals will be floated on an IF frequency equal to their carrier separation. The phases of the different signal will therefore not be constant relative to each other.

As number of carriers increase the probability of the separation frequency carriers aligning to form a peak is reduced. Simulations using multiple sine waves with a 600 kHz spacing indicate that the probability of a 4 carrier signal reaching its worst case is quite high (0.1%). As the number of carriers goes up the probability of a worst-case combination becomes lower, in this case with 500 timeslots worth of data the maximum value for 8 carrier is approx. 8.5 dB and approx. 9.5 dB for 16 carrier.

Section 3.3 of GSM 05.04 states:
“Before the first bit of the bursts as defined in GSM 05.02 enters the modulator, the state of the modulator is undefined. Also after the last bit of the burst, the state of the modulator is undefined. The tail bits (see GSM 05.02) define the start and the stop of the active and the useful part of the burst as illustrated in FIG. 3. Nothing is specified about the actual phase of the modulator output signal outside the useful part of the burst.”

This makes sense as the mobile recovers its phase information relative to the training sequence in the middle of the burst. The inventors of the present invention have identified that this specification leaves it open to a designer to change the phase at the start of the burst to any arbitrary value, and that this could advantageously be exploited to allow an improvement in efficiency.

Each EDGE burst can be regarded as an isolated event. As outlined above, the largest peak to average ratios are statistically rare; and so the probability of a peak occurring due to modulated signals adding to give a high PAR in any one multi-carrier burst is low. However, if a coincidence of signals that could add to cause such a peak were detected before the signal is passed to the power amplifier, such addition could be avoided by varying the phase of one or more of the carriers which would otherwise cause the peak. This technique is described in more detail below.

The signal under evaluation can be modelled as a complex envelope:

$$y ( t ) = {\sum }_{i = 1}^{no . \_of \_carriers} A ( t , i ) {ⅇ}^{( j {ω}_{i} t + {ϕ}_{i} )}$$

where A(t,i) is the term defined by modulation and e^{(jω}^{ᵢ}^{t+φ}^{ᵢ}⁾ describes the frequency location of single carrier signal within the multi-carrier band and the phase offset between them. The goal is to minimise the peak-to-mean ratio (PAR) of the transmitted signal.

$$PAR = \sqrt{\frac{max ( {\vert y ( t ) \vert}^{2} )}{mean ( {\vert y ( t ) \vert}^{2} )}}$$

In accordance with the signal model defined in previous section, there are several options for reducing the PAR of the output signal. First, the terms A(t,i) can be modified so that the PAR is minimised. In this case the term “clipping” is appropriate, as the modification creates an error (EVM) in the output signal. Alternatively, one can adjust the frequency ωᵢ terms of each carrier, but this causes a frequency error to the transmitted signal and it is limited by the specifications in and EDGE environment. A third option is to adjust the phase offset φ; of each carrier. In case the adjustment is done on a burst-by-burst basis, it doesn't cause any error to the transmitted signal and therefore it is considered as an alternative or supporting option for clipping algorithms.

Using an embodiment of the present technique, bursts where large peaks could occur are identified and the starting phase of one or more of the modulators is manipulated when one or more of the channels forming the burst are modulated, so as to avoid the peak occurring. The phase(s) of the carriers during a burst is (are) changed between bursts and held throughout the length of he burst in question. At the end of the burst the phase(s) may be changed again, or kept the same.

Numerous specific embodiments are available to reduce the peak amplitude. In general, two or more sets of the carrier signals that could (according to the standard for the communication system in question) be used to modulate a burst are established, and the one that would result in the lowest maximum amplitude for the signal that would result when the modulated signals are combined is selected for use.

In one embodiment, all the sets may be established and the one that would result in the lowest maximum amplitude is selected. In another embodiment, a pre-determined threshold is set for an acceptable maximum amplitude for a burst. Sets are established in turn and once a set is found that would result in the burst having a maximum amplitude below that threshold that burst is selected. It may sometimes happen that the first set to be selected satisfies the threshold, but on other iterations several sets may have to be tried. It may be necessary to set a maximum on the number of tries to be used, so as to keep the processing required within available bounds. Once that number of tries has been made the set that would have resulted in the lowest peak amplitude can be selected.

The establishment of the sets can be done in any convenient way. For example, it may be done by randomly altering the phase of one or more of the carrier signals. Alternatively, it may be done by deterministically altering the phase of one or more of the carrier signals. In one preferred embodiment, the phase alterations that are available are limited any one or more of π/2, π, and 3π/2. These rotations can be performed using only multiplications by 1 and −1, making them particularly convenient to perform. A rotation of 0 (no alteration) also satisfies this condition.

Which of the sets would result in the lowest maximum amplitude may be determined by performing the modulation measuring the maximum amplitude that results, and comparing the determined maxima; or by simulation.

The maximum may be an absolute maximum, or may be the peak to average ratio.

One example of an algorithm to implement the technique involves measuring the PAR for a multi-carrier burst and, if a certain level of PAR is recorded, giving the modulators are given an alternative random starting phase. This is a relatively simplistic algorithm for removing the peaks and is computationally somewhat intensive. More sophisticated algorithms could simply adjust the starting phase of a subset of the channels, and the offset could be determined in a coordinated fashion rather than randomly.

It should be noted that as the probability of a peak PAR occurring in any burst is low, it is acceptable to simply implement a random adjustment of the phase(s). Having changed the phase of the carriers to avoid one peak the probability of another occurring in the same burst is low.

The phase of the individual carriers relative to each other can be adjusted by varying the phase of the 3pi/8 phase rotation of the EDGE modulator. Other means for adjusting the phase could be used in other systems.

FIG. 6 illustrates the results of a simulation using the relatively simplistic algorithm described above. The results even for this algorithm show that for a 0.01% probability the peak to average ratio has reduced from 8 dB to approx 7 dB, a 1 dB improvement. Using the example amplifier described with reference to FIG. 1 this would result in an efficiency improvement from 18% to 21.5% (3.5% improvement), and a cost saving of $56 (200 W to 160 W peak power for 32 W average and assuming $1.4/W).

As the present technique is essentially predictive, and has to implement any phase rotations to the signal at the start of the RF burst, it requires the identification of a potential peak to be to done at least 1 timeslot in advance of the potential peak, so that corrective action taken in time. If such a delay is tolerable in the modulator of a potential installation then the technique may be implemented there alone. Otherwise, additional processing downstream of the modulator is called for.

In the coding process there is a considerable delay introduced into the link by the interleaving process. For a traffic channel this is done on a cycle of 114*4=456 data bits which are spread over 8 half timeslots and transmitted over 8 frames. The total transmission delay including an additional SCCH channel from the 1st burst to the last one in a block being (9*8)−7=65 bursts period or 37.5 ms. (See “GSM System for mobile Communications”; M Mouley, M Pautet Section 4.3.2).

At this point the information required to carry out the prediction is available and could be processed without any additional delay to the signal. The pre-distortion algorithms could then pass an appropriate starting phase for each burst to the modulator. In order to do the prediction correctly the interleaver of each physical channel should be able to share information about the different channels (including the channel number).

FIG. 7 shows schematically an apparatus for performing the present technique. The apparatus of FIG. 7 is for processing data from two channels, received by the apparatus at 1 and 2. The incoming data is delayed by respective delay units 3 and 4 to allow time for processing that occurs in block 7, and is then passed to respective modulators 5 and 6. At the modulators the incoming data streams are modulated burst-by-burst. The phase of each modulator is set by processing block 7. The outputs of the modulators are combined to form a multi-channel signal which is amplified by power amplifier 8 and then transmitted via antenna 9.

At processing block 7 includes a signal simulation unit 10 and stores 11, 12 which store the current phases of the modulators 5, 6. When the data representing a burst is received at 1, 2 the signal simulation unit simulates the multi-carrier signal that will result from the modulation of that data using the current phases of the modulators. The simulated multi-carrier signal is passed to a decision unit 13. If the PAR of the simulated multi-carrier signal does not go over a pre-set threshold then the decision unit takes no further action. If the PAR does exceed the threshold then the decision unit randomly changes the phases stored at 11 and 12 and passes the new phases to the modulators for use by them in modulating the current burst. The delay unit imposes a delay such that once this processing has been done the data for the burst is passed to the modulators for modulation according to the set phases.

The statistical trade-off between a low level of clipping and the average power level of the distortion products that are caused by it has been investigated. Soft clipping to reduce spectral distortion is also a possibility.

As indicated above, it is known that a signal with high PAR sets high demands on power amplifier linearity and therefore reduces achievable power efficiency and therefore increases the power consumption of the power amplifier. In order to improve the efficiency, algorithms are searched to reduce the peak-to-mean ratio of the transmitted signal. Clipping algorithms provide one method to for reducing the PAR with a cost of increasing the Error Vector Magnitude (EVM) of transmitted signal. Different clipping algorithms have already been studied in the case of a WCDMA signal and in accordance with the results some algorithms have been proposed for implementation.

Some algorithms for reducing the PAR will now be presented.

The characteristics of multi-carrier EDGE (8-PSK) signal are studied next and some limitations for the clipper performance are considered.

The PAR of one EDGE modulated signal is about 3.2 dB. Theoretically, in the case of a multi-carrier signal, the PAR is increased by 3 dB every time the number of carriers is doubled. On the other hand, according to the central-limit-theorem, the sum of large amount of random signals approaches signal with according to a Gaussian function and therefore the amplitude distribution of multi-carrier signal approaches the Rayleigh distribution as the amount of carriers increases. This is an acceptable approximation of the transmitted signal already with, say, 8 carriers and is used here due to its simplicity.

In this section some algorithms for adjusting the initial phase of a burst are considered. As indicated above, the initial phase adjustment has to be made before the actual modulation of the burst starts.

For comparison, two phase-setting algorithms were evaluated for the case of 8 carriers. The first involves restricting the phase resolution to 90 degrees and considering the optimum phase combination of four input signals. In the case of 8 input signals, pairs of signals are summed in random phase to form four signals. For the resulting four signals all combinations are created and the best is selected.

The second algorithm that has been studied sums two second signal to the first one with the best phase (using a selected resolution, here 45 degrees). After this, third one is added to the combination of the previous two signals, and so on for the other carriers.

In practice, the required frequency characteristics can be created by filtering an impulse with a filter bank each filter having the response of each sub-carrier.

The present invention is not limited to use in a GSM/EDGE system.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for forming a multi-carrier output signal for transmission in a communication system, the multi-carrier output signal being formed from a plurality of data signals each modulated with a respective one of a plurality of carrier signals, the method comprising:
establishing two or more sets of carrier signals, each set comprising each of the plurality of carrier signals and differing from the other set(s) in the phase of at least one of the carrier signals;
selecting the one of the sets of carrier signals that would, when used to form the multi-carrier signal, result in the multi-carrier output signal having the lowest maximum amplitude; and
forming the multi-carrier output signal from the plurality of data signals each modulated with the respective one of the plurality of carrier signals of that selected set.

2. A method as claimed in claim 1, comprising the step of determining the maximum amplitude of the multi-carrier output signal that would result from the use of a first set of carrier signals to form the multi-carrier signal, and if that maximum amplitude is above a predetermined threshold performing the said selecting and forming steps and otherwise forming the multi-carrier output signal from the plurality of data signals modulated with the respective one of the plurality of carrier signals of the first set.

3. A method as claimed in claim 1, wherein the said step of establishing comprises:
forming a first set of the plurality of carrier signals; and
forming the or each other set of the plurality of carrier signals by duplicating a previously formed set of the carrier signals but with the phase of one or more of the carrier signals altered by a random amount.

4. A method as claimed in claim 1, wherein the said step of establishing comprises:
forming a first set of the plurality of carrier signals; and
forming the or each other set of the plurality of carrier signals by duplicating a previously formed set of the carrier signals but with the phase of one or more of the carrier signals altered by a pre-determined amount.

5. A method as claimed in claim 4, wherein the pre-determined amount is selected from a set of predetermined amounts.

6. A method as claimed in claim 5, wherein the set of predetermined amounts comprises one or more of the values: π/2, π, 3π/2.

7. A method as claimed in claim 1, wherein the said step of selecting comprises:
for each of the sets of carrier signals: forming a multi-carrier signal by modulating each of the data signals with the respective carrier signal of that set, combining the modulated signals and determining the maximum amplitude of the combined signal.

8. A method as claimed in claim 1, comprising repeatedly forming one of the said sets of carrier signals and determining the maximum amplitude that the multi-carrier output signal would have if that set of carrier signals were used to form the multi-carrier signal, until the determined maximum amplitude is below a predetermined threshold.

9. A method as claimed in claim 1, wherein the communication system is a GSM, WCDMA or EDGE communication system.

10. A method as claimed in claim 1, wherein the multi-carrier output signal is a burst of the communication system.

11. A method as claimed in claim 1, wherein each of the data signals comprises more than 100 symbols.

12. A method as claimed in claim 1, comprising amplifying the multi-carrier output signal and transmitting the amplified signal via an antenna.

13. A method as claimed in claim 12, where the signal is amplified by means of a linear power amplifier.

14. A transmitter for forming a multi-carrier output signal for transmission in a communication system, the multi-carrier output signal being formed from a plurality of data signals each modulated with a respective one of a plurality of carrier signals, the transmitter comprising:
means for establishing two or more sets of carrier signals, each set comprising each of the plurality of carrier signals and differing from the other set(s) in the phase of at least one of the carrier signals;
means for selecting the one of the sets of carrier signals that would, when used to form the multi-carrier signal, result in the multi-carrier output signal having the lowest maximum amplitude; and
means for forming the multi-carrier output signal from the plurality of data signals each modulated with the respective one of the plurality of carrier signals of that selected set.

15. A transmitter for forming a multi-carrier output signal for transmission in a communication system, the multi-carrier output signal being formed from a plurality of data signals each modulated with a respective one of a plurality of carrier signals, the transmitter being configured to:
establish two or more sets of carrier signals, each set comprising each of the plurality of carrier signals and differing from the other set(s) in the phase of at least one of the carrier signals;
select the one of the sets of carrier signals that would, when used to form the multi-carrier signal, result in the multi-carrier output signal having the lowest maximum amplitude; and
form the multi-carrier output signal from the plurality of data signals each modulated with the respective one of the plurality of carrier signals of that selected set.

16. A method for forming a multi-carrier output signal for transmission in a communication system, the multi-carrier output signal being formed from a plurality of data signals each modulated with a respective one of a plurality of carrier signals, the method comprising:
establishing a set of carrier signals;
determining the maximum amplitude of the multi-carrier signal that would result from modulating each of the plurality of data signals with the respective one of the plurality of carrier signals of that set; and
if the determined maximum amplitude is below a pre-determined threshold, forming the multi-carrier signal by modulating each of the plurality of data signals with the respective one of the plurality of carrier signals of that set; and otherwise;
altering the phase of at least one of the carrier signals of the set, and forming the multi-carrier signal by modulating each of the plurality of data signals with the respective one of the plurality of carrier signals of the set, including the at least one carrier signal having an altered phase.
